(19) United States
(12) Patent Application Publication
(10) Pub. No.: US 2023/0156043 A1
(43) Pub. Date: May 18, 2023

(54) SYSTEM AND METHOD OF SUPPORTING DECISION-MAKING FOR SECURITY MANAGEMENT

(71) Applicant: Korea Internet & Security Agency, Naju-si (KR)

(72) Inventors: Do Won KIM, Naju-si (KR); Tae Eun KIM, Naju-si (KR); Ki Jong SON, Naju-si (KR); Seul Ki CHOI, Naju-si (KR); Jong Ki KIM, Naju-si (KR)

(73) Assignee: Korea Internet & Security Agency, Naju-si (KR)

(21) Appl. No.: 17/972,640

(22) Filed: Oct. 25, 2022

(30) Foreign Application Priority Data
Nov. 17, 2021 (KR) 10-2021-0158552

(51) Int. Cl. H04L 9/40

(52) U.S. Cl. CPC H04L 63/205; H04L 63/1416

(57) ABSTRACT

Disclosed is a system and a method of supporting a decision-making for security management to cause a security controller to rapidly take precautions against a threat, the system comprising: an interface unit configured to receive a request for support of a decision-making, and a processing unit configured to support at least one decision-making concerning materialization of the threat, the selection of a security event to be preferentially processed, or the recommendation of a most suitable response according to the request for the support of the decision-making.

### CROSS-REFERENCE TO RELATED APPLICATION

This application claims priority to Korean Patent Application No. 10-2021-0158552, filed on Nov. 17, 2021, in the Korean Intellectual Property Office, the entire contents of which are hereby incorporated by reference.

### BACKGROUND OF THE INVENTION

### Field of the Invention

The present invention relates to a system and a method of supporting a decision-making for security management, which cause a security controller to rapidly take precautions against a threat.

### Description of the Related Arts

Recently, frequency and exquisiteness in cyber attacks have increased. Threats, which occurred through the existing management systems and personal computers (PC), and so on, have extensively occurred through all the devices connected to the internet (Internet of Things devices), and large scale security events have been collected through various security solutions.

It usually takes for a controller (or an analyst) 10 minutes or more to analyze one threat event (alert), and according to importance of a threat to security, time is additionally required. Current manual analysis performed by controllers is leading to an increase in excessive work load because it causes an increase in repetitive analysis and response, and it is difficult to carry out consistent response because controllers’ know-how, experiences, and so on are different from one another, and results concerning time required for analysis and response are also different from one another.

The existing security systems have mostly simple types such as detecting pattern error and so on, and cannot carry out sorting and processing rapidly when high risk events causing an invasion to an operation and internal system occurs.

### SUMMARY OF THE INVENTION

The present invention provides a system and a method of supporting a decision-making for security management, which provide a controller with the priority order of security events to be processed using an artificial intelligence art.

Furthermore, the present invention provides a system and a method of supporting a decision-making for securing management, which cause Artificial Intelligence(AI) models to study by using information on counter-histories (event analysis, a response, a management result, and so on) rendered by a controller concerning the result of a security event response through strengthening learning.

Furthermore, the present invention provides a system and a method of supporting a decision-making for security management, which provide a security management center with a most suitable response for current circumstances by studying AI learning data, and feedback (compensation) information rendered by a controller concerning the result of a security event response through strengthening learning.

Furthermore, the present invention provides a system and a method of supporting a decision-making for security management, which generate connection information based on internal and/or external threat information of security events, providing estimated information about an internal attack path, and information about connection analysis through the materialization of data based on topology.

In order to solve the problems, a system of supporting a decision-making for security management according to some exemplary embodiment of the present invention may comprise: an interface unit configured to receive a request for support of a decision-making; and a processing unit configured to support at least one decision-making concerning materialization of a threat, the selection of a security event to be preferential processed, or the recommendation of a most suitable response according to the request for the support of the decision-making.

The processing unit may receive information on a request for materialization when receiving the request for the support of the decision-making, classifying the information into each type, extracting event feature information from the received information on the request for materialization when the classified type is a first type, generating a network topology based on assets information, extracting TTP information based on the received information on the request for materialization, matching the extracted TTP information with the extracted event feature information, generating an attack estimate path based on matching information between the extracted TTP information and the extracted event feature information, and generating threat materialization information based on the generated attack estimate path and the generated network topology.

The processing unit may inquiry into several pieces of threat information from a database when the classified type is a second type, generating information on connectivity among said several pieces of threat information through analysis on a connection among the inquired several pieces of threat information, and generating threat materialization information based on the information on connectivity among said several pieces of threat information.

The processing unit may receive and pre-process at least two or more security events when receiving the request for the support of the decision-making, sorting a first event to be preferentially processed from said at least two or more security events using an AI model based on strengthening learning, sorting a second event to be preferentially processed from said at least two or more security events using an AI model based on guidance learning, and generating a selection result of preferential processing based on the first event to be preferentially processed and the second event to be preferentially processed.

The processing unit may receive and pre-process a single security event when receiving the request for the support of the decision-making, recommending response information for the single security event using statics information on counter histories, recommending most suitable response information for the single security event using the AI model based on strengthening learning, and finally deciding a most suitable response on the basis of the recommended response information and the recommended the most suitable response information.

The system of supporting the decision-making for security management may further comprise a collection unit configured to collect feedback information and security data.

The system of supporting the decision-making for security management may further comprise a learning unit configured to generate and update the AI models through at least one of the strengthening learning and the guidance learning by using the security data as learning data.

A method of supporting a decision-making for security management according to some exemplary embodiment of the present invention may comprise: a step of receiving a request for support of a decision-making; and a step of supporting at least one decision-making concerning the materialization of a threat, the selection of a security event to be preferentially processed, and the recommendation of a most suitable response according to the request for the support of the decision-making.

The step of supporting the decision-making may comprise: a step of receiving information on a request for materialization when receiving the request for the support of the decision-making, and classifying the information into each type; a step of extracting event feature information from the received information on the request for materialization when the classified type is a first type; a step of generating a network topology based on assets information; a step of extracting TTP information based on the received information on the request for materialization; a step of matching the extracted TTP information with the extracted event feature information; a step of generating an attack estimate path based on information resulting from matching of the extracted TTP information with the extracted event feature information; and a step of generating threat materialization information based on the generated attack estimate path and the generated network topology.

The step of supporting the decision-making may further comprise: a step of inquiring into threat information from a database based on block information when the classified type is a second type; a step of generating information on connectivity among several pieces of threat information by analyzing a connection of the inquired several pieces of threat information; and a step of generating threat materialization information based on the information on the connectivity among said several pieces of threat information.

The step of supporting the decision-making may comprise: a step of receiving and pre-processing at least two or more security events when receiving the request for the support of the decision-making; a step of sorting a first event to be preferentially processed from said at least two or more security events using an AI based on strengthening learning; a step of sorting a second event to be preferentially processed from said at least two or more security events using an AI based on guidance learning; and a step of generating a selection result of pre-processing based on the first event to be preferentially processed and the second event to be preferentially processed.

The step of supporting the decision-making may comprise: a step of receiving and pre-processing a single security event when receiving the request for the support of the decision-making; a step of recommending response information for the single security event using statistics information on counter-histories; a step of recommending most suitable response information for the security event using the AI model based on strengthening learning; and a step of finally deciding a most suitable response based on the recommended response information and the recommended most suitable response information.

The method of supporting the decision-making for security management may further comprise a step of receiving feedback information and security data.

The method of supporting the decision-making for security management may further comprise a step of generating and updating the AI models through at least one of the strengthening learning and the guidance learning by using the security data as the learning data.

According to the present invention, because a controller is provided with information about the priority order of security events to be processed, and threat information, and information about materialization of a threat, a consistent response can be performed, and a security level can be improved.

Furthermore, according to the present invention, a high risk event which causes an invasion on an operating and external system can be rapidly selected and can be preferentially processed.

### BRIEF DESCRIPTION OF THE DRAWINGS

FIG. 1 is a block diagram illustrating a system of supporting a decision-making for security management according to some exemplary embodiments of the present invention.

FIG. 2 is a flow chart illustrating a method of supporting materialization of a threat to a security event according to some exemplary embodiments of the present invention.

FIG. 3A is an exemplary view for explaining a first type of threat materialization according to some exemplary embodiments of the present invention.

FIG. 3B is an exemplary view for explaining a second type of threat materialization according to some exemplary embodiments of the present invention.

FIG. 4 is a flow chart illustrating a method of supporting a selection of a security event to be preferentially processed according to some exemplary embodiments of the present invention.

FIG. 5 is a view for explaining one example of supporting the selection of the security event to be preferentially processed according to some exemplary embodiments of the present invention.

FIG. 6 is a flow chart illustrating a method of supporting the recommendation of a most suitable response according to some exemplary embodiments of the present invention.

FIG. 7 is a flow chart illustrating a data collection process according to some exemplary embodiments of the present invention.

FIG. 8 is a flow chart illustrating an AI learning process according to some exemplary embodiments of the present invention.

### DETAILED DESCRIPTION OF THE INVENTION

The terms “comprise”, “configure”, “have”, and so on described in the present specification mean should be construed as further comprising other constituent elements rather than excluding the existence of the other constituent elements because they mean that the corresponding constituent elements can be inherently provided, unless the context clearly indicates otherwise.

Furthermore, each of the terms “~ unit”, “module”, and so on descried herein means a unit of handling at least one function or operation, which can be embodied in the form of hardware or software, or a combination of the hardware and the software. Furthermore, the meanings of the articles “a”, “an”, and “the” and so on can be intended to include all the singular forms and the plural forms, unless the context describing the present invention in the present specification clearly indicates otherwise.

Hereinafter, some exemplary embodiments of the present invention are described in detail with reference to the accompanying drawings.

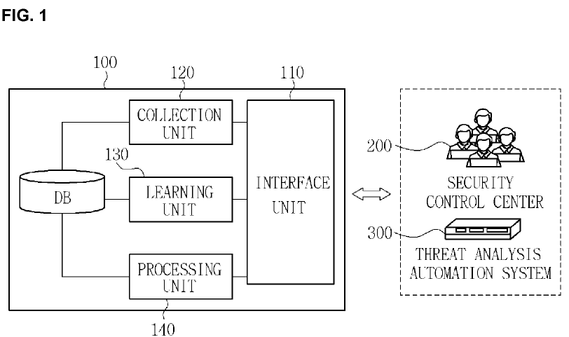

FIG. 1 is a block diagram illustrating a system of supporting a decision-making for security management according to some exemplary embodiments of the present invention.

The system of supporting a decision-making for security management (hereinafter referred to as the decision-making support system) 100 may comprise: an interface unit 110; a collection unit 120; a learning unit 130; and a processing unit 140.

Each of the constituent elements 110, 120, 130, or 140 may be an electronic device or a computing device comprising at least one processor and a memory.

At least one processor may be embodied into an application specific integrated circuit (ASIC), a digital signal processor (DSP), a programmable logic device (PLD), a field programmable gate array (FPGA), a central processing unit (CPU), a microcontroller and/or microprocessor, and so on.

The memory may comprise a storage medium, such as a flash memory, a hard disk, a solid state disk (SSD), a random access memory (RAM), a static random access memory (SRAM), a read only memory (ROM), a programmable read only memory (PROM), an electrically erasable and programmable ROM (EEPROM), an erasable and programmable ROM (EPROM) and/or an embedded multimedia card (eMMC), and so on.

The interface unit 110 may manage the input and output of internal and/or external data of the decision-making support system 100. The interface unit 110 may support the transmission and receipt of data among the decision-making support system 100, and a security management center 200 and/or a threat analysis automation system 300.

The security management center 200 or the threat analysis automation system 300 may receive a normal alert and/or a malignant alert.

Safety equipment may generate an alert, if an event, which occurs from a device such as a security system, a server, a terminal, and so on when a person who delivers an attack and/or a normal user, and so on approach the inside and the outside of a company, is consistent with a detection rule pre-defined.

The security management center 200 or the threat analysis automation system 300 may request the decision-making support system 10 to support a decision-making, namely, to select a security event to be preferentially processed in case that the security event exceeds a critical value of a pre-determined immediate event.

Furthermore, the security management center 200 or the threat analysis automation system 300 may request the decision-making support system 100 to materialize a security event threat during a detailed analysis process. The security management center 200 or the threat analysis automation system 300 may request the decision-making support system 100 to render a most suitable response. The security management center 200 or the threat analysis automation system 300 may receive results, namely a list of events to be preferentially processed, information on materialization of a threat to security, and/or information on a most suitable response, transmitted from the decision-making support system 100. The security management center 200 or the threat analysis automation system 300 may take measures for an event to be highly preferentially processed based on the list of the events to be preferentially processed. The security management center 200 or the threat analysis automation system 300 may execute the most suitable response based on the most suitable response information. The security management center 200 or the threat analysis automation system 300 may judge security threat information based on information on materialization of a threat to security.

The collection unit 120 may collect feedback information or security information.

The feedback data may be data resulting from each function of the processing unit 140, real judgment information rendered by a security controller (the admission of a result, a change, deletion, and so on), and so on.

The security data may be an internal security solution (SIEM and the like), event information (e.g., an IP and a port of a starting place, an IP and a port of a destination, a type of an attack, a result as to correct detection and wrong detection, a hash, a date of generation, and so on), assets information (e.g., an IP of a system, an IP of a terminal, importance per assets, and so on), internal threat information (e.g., an existing history), external threat information (cyber threat intelligence, CTI) (e.g., an attack IP, a C & C IP, a hash, and so on) and/or information on tactics and strategies rendered by an attacker (e.g., Tactics Techniques Procedure, TTPs), and so on. The data collection unit 120 may carry out a process of pre-processing so that collected security data is used as learning data.

The collection unit 120 may receive result data (concerning an event, a career, and so on) outputted from the processing unit 140, and security controller’s feedback information (concerning admission, admission after a change, exception, and so on), and may classify them according to their respective types. The feedback information may be feedback information about the result of decision-making rendered by the processing unit 140. The collection unit 120 may cause the result data and the security controller’s feedback information to be linked with each other. The collection unit 120 may pre-process data to be used in strengthening learning as a reward function.

The collection unit 120 may receive information on a counter-history (an event type, a response process, an analysis process, judgment, and so on) rendered by the security controller and collected based on the input of a user. The collection unit 120 may collect security data and may classify the security data into each type. The collection unit 120 may extract information on features per unit datum. The collection unit 120 may pre-process data to be used in data learning or materialization, and so on.

A database(DB) may save event information, information on a result of supporting a decision-making, feedback information rendered by the security controller, information on an external threat, and so on. The data set for the learning of AI, and original data may be saved in the DB. Security data and feedback information collected by the collection unit 120 may be saved in the DB.

The learning unit 130 may generate and update a guidance learning model and a strengthening learning model used by the processing unit 140 through an AI learning. The learning unit 130 may manage a schedule designated by a user to generate the AI learning model. The learning unit 130 may make a learning according to a part or a condition (time, data information, and so on) which the user inputs. The learning unit 130 may request data required for the learning based on the information set in the schedule, namely, learning data from the database. The learning unit 130 may carry out pre-processing so that the learning data provided from the database can be used in learning of AI.

The learning unit 130 may extract a data feature from the learning data. The learning unit 130 may carry out strengthening learning by inputting the feedback information rendered by the security controller as a reward function. The learning unit 130 may generate strengthening learning model by using the feedback information as a reward function so as to carry out the strengthening learning.

The learning unit 130 may calculate a final risk level (e.g., high, moderate, low, and zero) by making inquiries as to information on an internal threat, a risk level according to each event type, information on an external threat, and so on. The learning unit 130 may provide the learning data with labeling based on the calculated risk levels. The learning unit 130 may generate a guidance learning model by carrying out guidance learning using information on a security event feature and so on. The risk levels used in the labeling are not used in a feature. The learning unit 130 may verify and appraise capability of the guidance learning model. The learning unit 130 may carry out re-learning by adjusting a weighted value when no result of verification and evaluation reaches a standard performance value predetermined by the user.

The learning unit 130 may apply the AI models generated from the strengthening learning and the guidance learning to the processing unit 140.

The processing unit 140 may provide the controller with intuitive information by visualizing information on a threat through relevant analysis when information on a security event or block (e.g., an IP, a threat type, and so on) is inputted. The processing unit 140 may provide information on the priority order of a security event which should be most preferentially processed in a current circumstance through each guidance learning model and/or strengthening learning model when a large number of event lists are inputted. The processing unit 140 may provide information on the best response in the current circumstance on the basis of the AI models based on strengthening learning.

The processing unit 140 may receive information on a request for materialization and may classify it into each type. The processing unit 140 may classify the information on the request for materialization into a first type when the information is event information, and into a second type when the information is block information.

The processing unit 140 may extract information, by which a threat can be distinguished from the other, such as an IP, a name of detection, and so on from the received event information. The processing unit 140 may generate topology based on assets information and may match TTP analysis information with information on an event feature. The processing unit 140 may make inquiries as to network topology information generated or inputted previously, and if no network topology information exists, the processing unit 140 may generate the network topology information. The processing unit 140 may extract TTP information, thereby matching it with information on an event feature. The processing unit 140 may generate an actual access path and an attack estimate path based on the matched information.

When the classified type is the second type, the processing unit 140 may inquire data from the database by discrimination based on block connection information inputted by an external user. The processing unit 140 may connect the inquired data to one another according to the order of block connection.

The processing unit 140 may generate information on materialization of a threat. The processing unit 140 may transform estimated information on an attack path and threat connection information to be inputted in a data visualization tool into the first type of materialization data and the second type of materialization data. The processing unit 140 may transmit the generated threat materialization information to the security management center 200 and/or the threat analysis automation system 300.

The processing unit 140 may carry out pre-processing by receiving a large number of a large amount of security events. The processing unit 140 may carry out pre-processing of the received security events to be inputted in the AI models. The processing unit 140 may determine whether the received events based on strengthening learning should be pre-processed or not. The processing unit 140 may classify pre-processing of the received events based on guidance learning into four levels. The four levels of the pre-processing may be divided into a high level, a moderate level, a low level, and a zero level. The processing unit 140 may re-classify the events to be processed preferentially classified into four levels under consideration of time required for making a response, and so on, and in case that non-processed events are continuously piled up or are inputted, the processing unit 140 may re-classify them according to each designated schedule. The processing unit 140 may collect and process results of preferential processing of the events determined in the strengthening learning and the guidance learning, thereby performing transform of the data so that the data can be transmitted to the security management center 200 or the threat analysis automation system 300.

The processing unit 140 may and receive and pre-process information on the single event. The processing unit 140 may recommend information on a response using information on existing statistics for counter-histories. The processing unit 140 may recommend information on the most suitable response for the received event based on the strengthening learning model. The processing unit 140 may request re-recommendation in case that the recommended response is not effective to be used in the current system as a result of examining whether or not it can be used in the current system. The processing unit may receive the result of the response decided finally, and may transform it into data which can be transmitted to the security management center 200 or the threat analysis automation system 300.

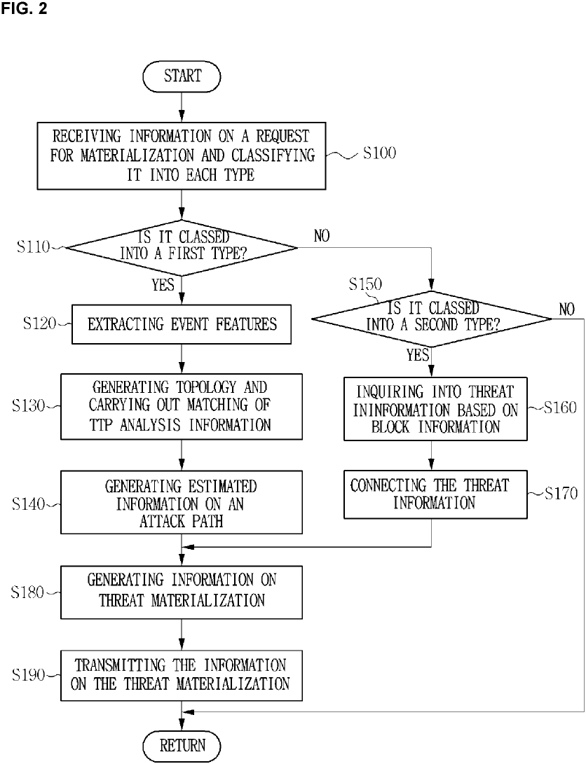

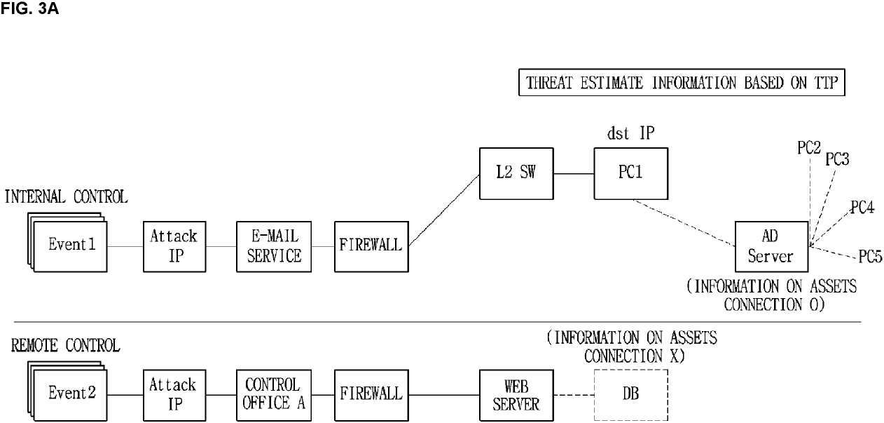

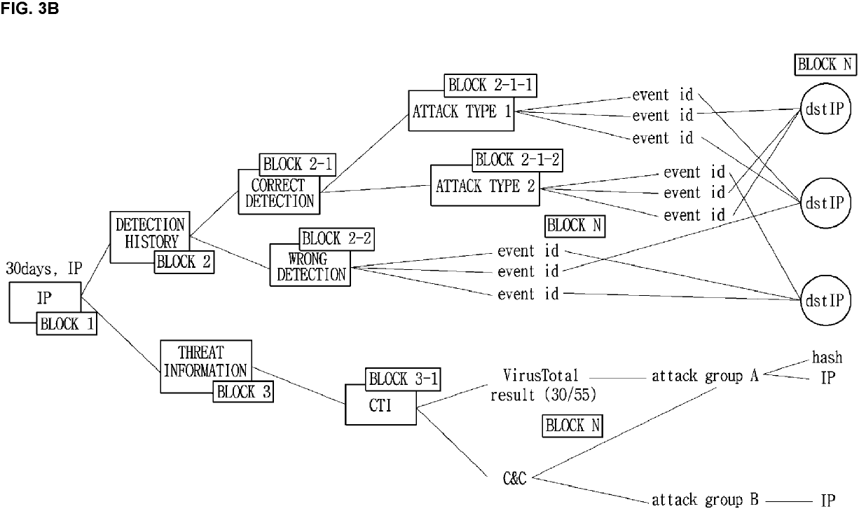

FIG. 2 is a flow chart illustrating a method of supporting materialization of a threat to a security event. FIG. 3A is an exemplary view for explaining the first type of threat materialization. FIG. 3B is an exemplary view for explaining the second type of threat materialization.

Referring to FIG. 2, the processing unit 140 may receive information on a request for materialization and may classify it according each type S100. The processing unit 140 may receive information on a request for threat materialization from the security management center 200 and/or the threat analysis automation system 300. In case that the information on the request for materialization included in the request for materialization received is event information, the processing unit 140 may decide it as a first type, and in case that the information on the request for materialization is block information, the processing unit 140 may decide it as a second type.

The processing unit 140 may confirm whether or not information classified into each type is in the first type S110.

In case that the information belongs to the first type, the processing unit 140 may extract information on an event feature from the information on the request for materialization received (S120). The processing unit 140 may extract information (i.e., event feature information), which causes discrimination of a threat such as an IP, the name of detection, and so on, from at least one piece of event information for which materialization is required.

The processing unit 140 may generate network topology based on assets information and may match TTP analysis information with it S130. The processing unit 140 may inquiry information on the network topology generated or inputted previously. When the existing network topology is checked up, the processing unit 140 may use the corresponding network topology, and when no existing network topology is checked up, the processing unit may generate network topology based on internal assets information. Furthermore, the processing unit 140 may extract TTP information based on at least one piece of event information and may match the event feature information with the extracted TTP information.

The processing unit 140 may generate an actual access path and an attack estimate path based on information resulting from matching between the extracted TTP information and the event feature information S140.

When the type classified in step S110 is not the first type, the processing unit 140 may confirm whether or the type classified is the second type S150.

The processing unit 140 may inquire threat information from the database based on the block information which requests materialization S160. The block information may be inputted by an external user and may comprise block connection information for relevant analysis.

The processing unit 140 may connect various pieces of inquired threat information to one another S170. The processing unit 140 may connect various pieces of inquired threat information to one another according to a block connection order based on the block connection information. In other words, the processing unit 140 may generate information on connectivity among various pieces of inquired threat information.

The processing unit 140 may generate information on threat materialization on the basis of information on connectivity among estimate information on an attack path and/or threat information S180. The processing unit 140 may transform the information on connectivity among estimate information on an attack path and/or threat information into materialization data (data as to visualization) for inputting it in a data visualization tool.

The processing unit 140 may transmit the generated information on materialization of a threat to the security management center 200 and/or the threat analysis automation system 300 S190. The security management center 200 and the threat analysis automation system 300 may output the information on threat materialization in a display using the data visualization tool.

According to one example, the processing unit 140 may generate estimate information on a threatening attack through TTP connection analysis based on one piece of attack event information as illustrated in FIG. 3A.

According to the other example, the processing unit 140 may materialize threat information on the basis of information on a specific IP and a term. To do so, the processing unit 140 may generate information on connectivity on the basis of information on the connection of blocks which a user desires to obtain. The processing unit 140 may materialize the threat information based on the generated information on the connectivity.

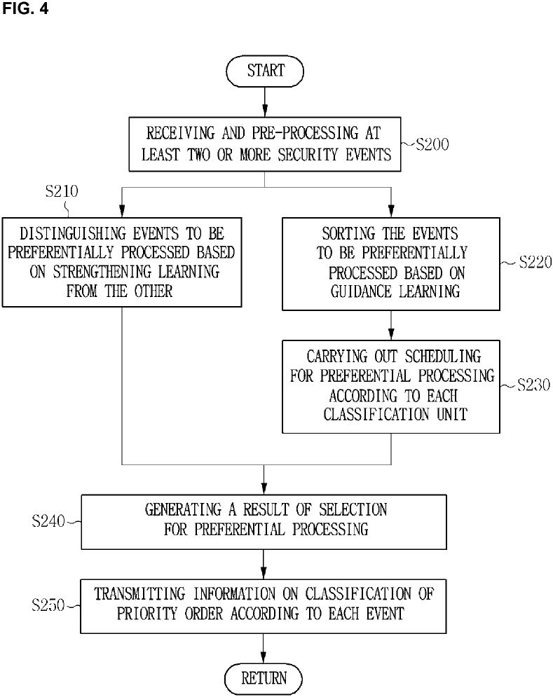

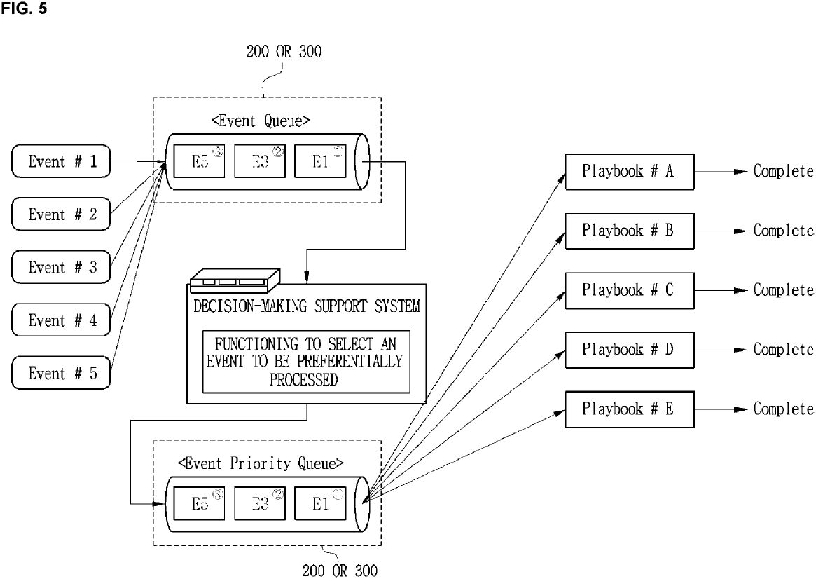

FIG. 4 is a flow chart illustrating a method of supporting a selection of a security event to be preferentially processed according to some exemplary embodiment of the present invention. FIG. 5 is a view for explaining one example concerning support for the selection of the security event to be preferentially processed.

When receiving a request for a selection of preferential processing of security events, the processing unit 140 may receive at least two or more security events, thereby carrying out pre-processing S200. The processing unit 140 may receive the request for the selection of preferential processing of the security events. The processing unit 140 may receive a large number or a large amount of security events included in the request for the selection of pre-processing of the security events. The processing unit 140 may pre-process the received security events in order to input it in an AI model.

The processing unit 140 may distinguish any security event to be preferentially processed from at least two or more security events received on the basis of strengthening learning S210. The processing unit 140 may sort the event to be preferentially processed from at least two or more security events based on the AI model based on strengthening learning. In the other words, the processing unit 140 may sort the security event for which preferential processing is required from at least two or more security events.

The processing unit 140 may classify at least two or more security events received into each preferential-processing grade on the basis of guidance learning S220. The preferential-processing grade can be divided into four levels, such as a high level, a moderate level, a low level, and a zero level. The processing unit 140 may classify at least two or more security events into four levels according to a risk level using the AI model based on guidance learning.

The processing unit 140 may carry out scheduling for preferential-processing in a classification unit S230. The processing unit 140 may re-classify the security events under consideration of time required for carrying out corresponding processing, and so on with respect to the security events according each classified grade of preferential-processing. The processing unit 140 may re-classify each grade according to a designated schedule when non-processed security events are continuously piled up or are inputted.

The processing unit 140 may generate a result of selecting events to be preferentially processed from a result of classifying an event to be preferentially processed on the basis of strengthening learning, and a result of classifying an event to be preferentially processed on the basis of guidance learning S240. The processing unit 140 may collect and process a result of preferential processing of the events decided from the strengthening learning and guidance learning, and thus may carry out the transform of the result into data so that the data can be transmitted to the security controller of the security management center 200 or the threat analysis automation system 300.

The processing unit 140 may transmit the generated result of the selection of preferential processing to the security management center 200 and/or the threat analysis automation system 300 S250.

Referring to FIG. 5, the security management center 200 and/or the threat analysis automation system 300 may transmit a request for the selection of events to be preferentially processed to the decision-making support system 100 when receiving security events exceeding the capacity of an event queue (i.e., a threshold of processing). The decision-making support system 100 may decide the priority order of security events, namely, the order of pre-processing of the security events by analyzing information on security events included in the received request. The decision-making support system 100 may transmit information on the preferential order of pre-processing of the security events to the security management center 200 and/or the threat analysis automation system 300. The security management center 200 and/or the threat analysis automation system 300 may input the information on the security events based on the information on the preferential order of the security events into the queue of event priority order, and may execute a playbook corresponding to each security event in the inputted order, thereby performing response.

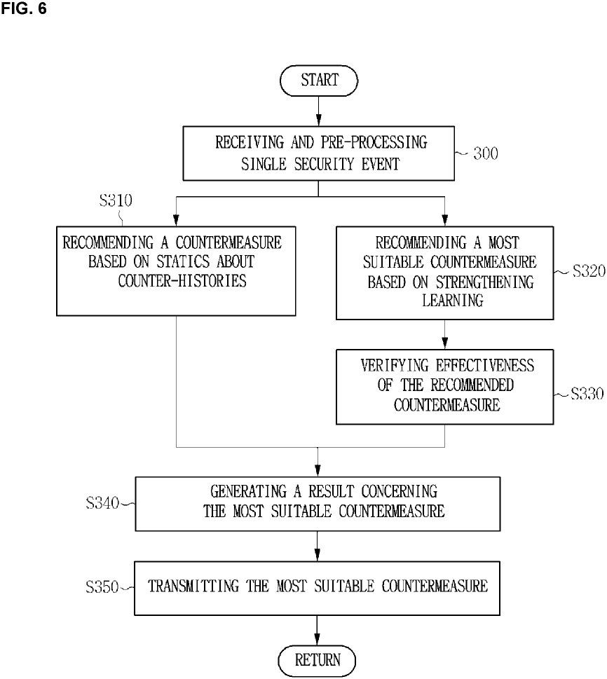

FIG. 6 is a flow chart illustrating a method of supporting recommendation of the most suitable response according to some exemplary embodiment of the present invention.

The processing unit 140 may carry out pre-processing by receiving a single security event when receiving a request for recommendation of the most suitable response S300. The processing unit 140 may receive the request for recommendation of the most suitable response from the security management center 200 and/or the threat analysis automation system 300. The processing unit 140 may carry out pre-processing by receiving information on the single event included in the request for recommendation of the most suitable response.

The processing unit 140 may propose information on a response for the received single security event using information about existing statistics based on a response history S310.

The processing unit 140 may propose information about the most suitable response for the received single security event based on strengthening learning S320. The processing unit 140 may recommend information about the most suitable response for the received single security event using the AI model (strengthening learning model) generated through strengthening learning.

The processing unit 140 may carry out verification of effectiveness concerning the most suitable response recommended S330. The processing unit 140 may decide whether the effectiveness is verified or not by inspecting whether or not the most suitable response recommended is available in the current system. The processing unit 140 may again recommend a different most suitable response when effectiveness is not verified.

The processing unit 140 may finally decide the most suitable response based on a response based on the statics of counter-histories and a response based on strengthening learning S340. The processing unit 140 may transform the result concerning the most suitable response decided finally into data so that the data can be transmitted to the security controller or the threat analysis automation system 300.

The processing unit 140 may transmit the most suitable response determined finally to the security management center 200 and/or the threat analysis automation system 300 S350.

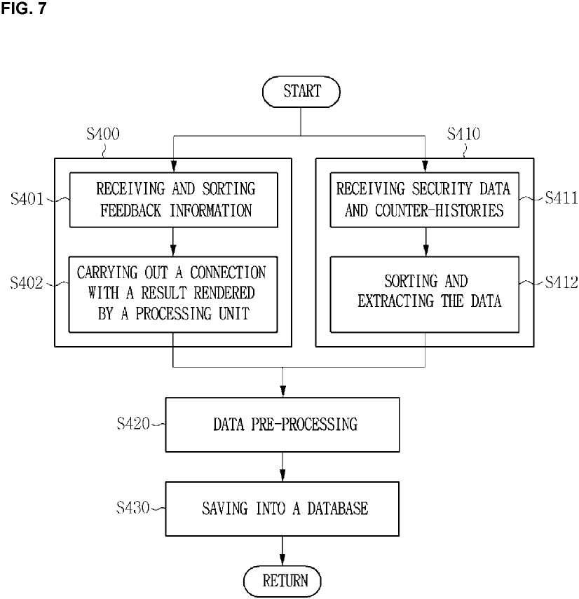

FIG. 7 is a flow chart illustrating a process of collecting data according to some exemplary embodiments of the present invention.

Referring to FIG. 7, the collection unit 120 may collect feedback information S400. The collection unit 120 may receive the feedback information, thereby classifying it according to each type S401. At this time, the feedback information may be result data (information on events, histories, and so on) outputted from the processing unit 140, feedback information (information on admission, admission after a change, exception, and so on) rendered by the security controller, and so on. The collection unit 120 may match the result data of the processing unit 140 with the feedback information rendered by the security controller S402.

The collection unit 120 may collect security data and information on a response history S410. The collection unit 120 may receive the information on a response history (information on event types, the process of response, determination, and so on) rendered by the security controller, which is collected based on input of the system or the user’s input, and the security data, such as external data threatening to security, data (events and so on) concerning internal security solutions (SIEM and the like), information on tactics and strategies rendered by an attacker (TTPs), internal assets information, and so on S411. The collection unit 120 may classify the collected data into each type, and may extract feature information according to each datum S412.

The collection unit 120 may pre-process the collected feedback information, security data, and a counter-history S420. The collection unit 120 may carry out data pre-processing in order to use the collected feedback information in strengthening learning as a reward function. The collection unit 120 may carry out data pre-processing so that the collected security data and counter-histories can be used.

The collection unit 120 may save the pre-processed data (information) in the database S430. The original data collected from the collection unit 120, and the learning data pre-processed by the collection unit 120 may be saved in the database.

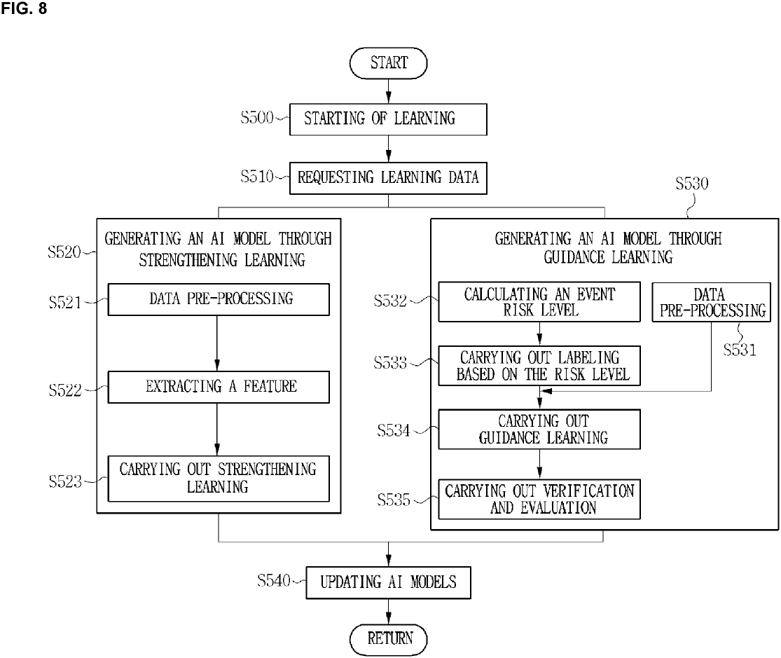

FIG. 8 is a flow chart illustrating a learning process of AI according to some exemplary embodiments.

The learning unit 130 may disclose learning for AI models according to a pre-fixed schedule S500. The learning unit 130 may manage the schedule designated by the user for the generation of AI models. The learning unit 130 may carry out learning according to a part or a condition (time, data information, and so on) inputted by the user.

When disclosing the learning, the learning unit 130 may request data (i.e., learning data) required for the learning based on information set up in the schedule from the database S510. The learning unit 130 may access the learning data from the database.

The learning unit 130 may generate an AI model (a model based on strengthening learning) by carrying out strengthening learning using the learning data S520. The learning unit 130 may pre-process the learning data to be used in strengthening learning S521. The learning unit 130 may extract a data feature from the learning data pre-processed S522. The learning unit 130 may carry out strengthening learning based on the data feature extracted S523. At this time, the learning unit 130 may carry out strengthening learning by using the feedback information rendered by the security controller as a reward function.

The learning unit 130 may generate an AI model (a model based on guidance learning) by carrying out guidance learning using learning data S530. The learning unit 130 may pre-process the learning data to be used in guidance learning S531. The learning unit 130 may calculate each risk level of security events within the learning data S532. The learning unit 130 may calculate each final risk level of the security events by inquiring internal threat information, a risk level according to each type of the events, an external threat information, and so on based on the information on properties of the security events included in the learning data. The learning unit 130 may provide the learning data with labeling based on the risk levels calculated S533. The learning unit 130 may carry out guidance learning using the information on properties of the security events, and so on S534. The risk levels used in labeling are not used in a feature. The learning unit 130 may verify and evaluate performance of the AI model generated through guidance learning S535. The learning unit 130 may carry out re-learning by adjusting a weighted value when no result of evaluation reaches a standard performance value pre-fixed by the user.

The learning unit 130 may update the AI models already applied to the processing unit 140 using the AI models generated through strengthening learning and guidance learning S540.

As described above, although it is described that all the constituent elements, which form the exemplary embodiments of the present invention, are combined into one, or operate in a state of being combined with one another, the present invention is not necessarily limited to these exemplary embodiments. That is, all the constituent elements may operate in a state of one or more constituent elements being selectively combined with each other, if this falls within the scope of the purpose of the present invention. Also, all the constituent elements may be embodied into their respective independent hardware, or may be embodied into a computer program having a program module which perform some functions or all the functions mixed in one piece or a plurality pieces of hardware in a state of some or all of the constituent elements being mixed selectively. Codes and code segments which forms the computer program could be easily derived by those having ordinary skill in the technical field of the present invention. This computer program may be saved in a computer readable media, may be readable and may be executed by a computer so that the exemplary embodiments of the present invention can be embodied.

What is claimed is:

1. A system of supporting decision-making for security management, comprising:
an interface unit configured to receive a request for support of a decision-making; and
a processing unit configured to support at least one decision-making concerning materialization of a threat, the selection of a security event to be preferentially processed, or recommendation of a most suitable response according to the request for the support of the decision-making.

2. The system of claim 1, wherein the processing unit
receives information on a request for materialization when receiving the request for the support of the decision-making, and classifying the information into each type,
extracting event feature information from the received information on the request for materialization when the classified type is a first type,
generating network topology based on assets information,
extracting information on TTP information based on the received information on the request for materialization,
matching the extracted TTP information with the extracted event feature information,
generating an attack estimate path based on matching information between the extracted TTP information and the extracted event feature information, and
generating threat materialization information based on the generated attack estimate path and the generated network topology.

3. The system of claim 2, wherein the processing unit
inquires into several pieces of threat information from a database when the classified type is a second type,
generating information on connectivity among the several pieces of threat information through connection analysis of the inquired several pieces of threat information, and
generating threat materialization information based on the information on connectivity among the several pieces of threat information.

4. The system of claim 1, wherein the processing unit
receives and pre-processes at least two or more security events when receiving the request for the support of the decision-making,
sorting a first event to be preferentially processed from said at least two or more security events using an artificial intelligence (AI) model based on strengthening learning,
sorting a second event to be preferentially processed from said at least two or more security events using an artificial intelligence (AI) model based on guidance learning, and
generating a selection result of preferential processing based on the first event to be preferentially processed and the second event to be preferentially processed.

5. The system of claim 1, wherein the processing unit
receives and pre-processes a single security event when receiving the request for the support of the decision-making,
recommending response information for the single security event using statics information on counter histories,
recommending most suitable response information for the single security event using the AI model based on strengthening learning, and
finally deciding a most suitable response on the basis of the recommended response information and the recommended the most suitable response information.

6. The system of claim 1, further comprising a collection unit configured to collect feedback information and security data.

7. The system of claim 6, further comprising a learning unit configured to generate and update the AI models through at least one of the strengthening learning and the guidance learning by using the security data as learning data.

8. A method of supporting a decision-making for security management, comprising:
a step of receiving a request for support of a decision-making; and
a step of supporting at least one decision-making concerning materialization of a threat, selection of security event pre-processing, and recommendation of a most suitable response according to the request for the support of the decision-making.

9. The method of claim 8, wherein the step of supporting the decision-making comprises:
a step of receiving information on a request for materialization when receiving the request for the support of the decision-making, and classifying it into each type;
a step of extracting event feature information from the received information on the request for materialization when the classified type is a first type,
a step of generating network topology based on assets information;
a step of extracting TTP information based on the received information on the request for materialization;
a step of matching the extracted TTP information with the extracted event feature information;
a step of generating an attack estimate path based on information resulting from matching of the extracted TTP information with the extracted event feature information; and
a step of generating threat materialization information based on the generated attack estimate path and the generated network topology.

10. The method of claim 9, wherein the step of supporting the decision-making further comprises:
a step of inquiring into threat information from a database based on block information when the classified type is a second type;
a step of generating information on connectivity among several pieces of threat information by analyzing a connection of the inquired several pieces of threat information; and
a step of generating threat materialization information based on the information on the connectivity among said several pieces of threat information.

11. The method of claim 8, wherein the step of supporting the decision-making comprises:
a step of receiving and pre-processing at least two or more security events when receiving the request for the support of the decision-making;
a step of sorting a first event to be preferentially processed from said at least two or more security events using an artificial model (AI) based on strengthening learning;
a step of sorting a second event to be preferentially processed from said at least two or more security events using an artificial model (AI) based on guidance learning; and
a step of generating a selection result of pre-processing based on the first event to be preferentially processed and the second event to be preferentially processed.

12. The method of claim 8, wherein the step of supporting the decision-making comprises:
a step of receiving and pre-processing a single security event when receiving the request for the support of the decision-making;
a step of recommending response information for the single security event using statistics information on counter-histories;
a step of recommending information on a most suitable response for the security event using the AI model based on strengthening learning; and
a step of finally deciding a most suitable response based on the recommended response information and the recommended most suitable response information.

13. The method of claim 8, further comprising a step of receiving feedback information and security data.

14. The method of claim 13, further comprising a step of generating and updating the AI models through at least one of the strengthening learning or the guidance learning by using the security data as learning data.
